(19) United States
(12) Patent Application Publication
(10) Pub. No.: US 2026/0214768 A1
(43) Pub. Date: Jul. 23, 2026

(54) OPTOELECTRONIC CIRCUIT COMPRISING LIGHT-EMITTING DIODES

(71) Applicant: EASII IC, Grenoble (FR)

(72) Inventors: David GRAS, Echirolles (FR); Arthur VEITH, Saint Martin le Vinoux (FR)

(21) Appl. No.: 19/143,647

(22) PCT Filed: Dec. 26, 2023
(86) PCT No.: PCT/FR2023/052122

§ 371 Date: Jul. 9, 2025

(30) Foreign Application Priority Data
Dec. 26, 2022 (FR) 22/14514

(51) Int. Cl. H05B 45/48

(52) U.S. Cl. CPC H05B 45/48

(57) ABSTRACT

An optoelectronic circuit comprising including_a first power supply terminal and a second reference terminal the first power supply terminal and the second reference terminal being intended to be connected to a voltage source that delivers, to the optoelectronic circuit, a variable voltage containing alternating increasing positive phases and decreasing positive phases. The optoelectronic circuit includes: sets of light-emitting diodes, the sets being connected to one another in series; conduction components wherein each conduction component is associated with only one of the sets of light emitting diodes; connecting circuits, and a control circuit having a differential amplifier and the same number of output stages as there are conduction components in the optoelectronic circuit.

### CROSS-REFERENCE TO RELATED APPLICATIONS

This application is a 35 U.S.C. § 371 National Stage patent application of no. PCT/FR2023/052122, filed on 26 Dec. 2023, which claims the benefit of French patent application no. 22/14514, filed on 26 Dec. 2022, the disclosures of which are incorporated herein by reference in their entirety.

### TECHNICAL FIELD

The present disclosure concerns an optoelectronic circuit comprising several sets of light-emitting diodes allowing to emit light when the optoelectronic circuit is powered, the optoelectronic circuit comprising a first power supply terminal and a second reference terminal, the first power supply terminal and the second reference terminal being intended to be connected to a voltage source delivering to the optoelectronic circuit a variable voltage containing an alternation of increasing positive phases and decreasing positive phases, the optoelectronic circuit comprising said sets of light-emitting diodes connected in series and connected to the first power supply terminal as well as a plurality of conduction components.

### BACKGROUND

It is known that an optoelectronic circuit comprising sets of light-emitting diodes must be able to be powered with a variable voltage, for example an alternating voltage, in particular a sinusoidal voltage, such as the mains voltage. The voltage applied to each set of light-emitting diodes must be greater than the sum of the threshold voltages of the light-emitting diodes in this set so that they emit light. The number of light-emitting diodes emitting light gradually increases during an increasing phase of the supply voltage and gradually decreases during a decreasing phase of the supply voltage.

One drawback is that it is possible to have an alternation of increasing light emission phases, decreasing light emission phases, and phases of absence of light emission by the optoelectronic circuit when the supply voltage is insufficient and therefore does not allow powering any of the light-emitting diodes. This creates potential flickering effects visible to the naked eye and visual discomfort, as well as stroboscopic effects involving a change in the perception of the movement of objects.

Document EP322359051 describes an optoelectronic circuit that allows solving this problem by reducing the duration of absence of light emission, or even eliminating it. To achieve this, the current flowing through the light-emitting diodes is maintained at a substantially continuous value. However, as a result, the power value in the light-emitting diodes increases at the same time as the voltage applied by the voltage source. This variation in power represents a drawback with respect to certain increasingly strict administrative and regulatory regulations in this area, which attempt to limit stroboscopic effects.

### SUMMARY

The present disclosure aims to provide an optoelectronic circuit of the aforementioned type that addresses all or some of the drawbacks mentioned above in relation to the state of the art.

In particular, the aim of the disclosure is to provide an optoelectronic circuit of the aforementioned type that meets at least one of the following advantages:
avoid phases of increasing and decreasing light emission,
avoid moments of extinction of the diode sets,
provide visual comfort,
have limited power consumption,
have limited heating effects.

This aim can be achieved by implementing an optoelectronic circuit comprising a first power supply terminal and a second reference terminal, the first power supply terminal and the second reference terminal being intended to be connected to a voltage source delivering to the optoelectronic circuit a variable voltage containing an alternation of increasing positive phases and decreasing positive phases, the optoelectronic circuit comprising:
sets of light-emitting diodes linked together in a series circuit, which series circuit being linked to the first power supply terminal,
a plurality of conduction components where each conduction component is associated with a single one of the sets of light-emitting diodes, each conduction component having a variable electrical conductance as a function of a control signal, each conduction component comprising a first terminal, a second terminal and a third terminal,
a plurality of connection circuits, the second reference terminal being linked to each set of light-emitting diodes by one of said connection circuits, each connection circuit on the one hand comprising one of said conduction components and at least one resistive component connected in series with said conduction component of said connection circuit, on the other hand being configured so that the first terminal of the conduction component is linked to the set of light-emitting diodes associated with it and that a first connection terminal of the resistive component is connected to the second terminal of the conduction component of said connection circuit and that a second connection terminal of the resistive component is linked to the second reference terminal,
a control circuit comprising a differential amplifier and as many output stages as there are conduction components comprised in the optoelectronic circuit, each of said output stages being linked to the third terminal of one of said conduction components, the control circuit being adapted to provide, for each connection circuit, the control signal based on the comparison between, on the one hand, a first voltage taken between a first potential, between the first connection terminal of the resistive component and the second terminal of the conduction component of this connection circuit, and a second reference terminal, and on the other hand, at least one second voltage identical for all the conduction components, the control circuit being adapted to regulate the first voltage to track the second voltage offset by a third voltage, different for each output stage of the control circuit.

This optoelectronic circuit advantageously makes it possible, at substantially constant power, to limit energy consumption and heating issues, while avoiding the risk of periods of variation in light emission, thus promoting visual comfort by avoiding any uncomfortable stroboscopic effect.

Some preferred, but not limiting, aspects of this optoelectronic circuit are as follows.

According to one embodiment, the sets of light-emitting diodes are connected together so as to constitute a light-emitting circuit in which the sets of light-emitting diodes are in series with each other, the light-emitting circuit having a first end electrically connected to the first power supply terminal and a second end linked to a node; the optoelectronic circuit comprises as many resistive components as there are sets of light-emitting diodes, and said resistive components are connected in series with each other, between the node and the second reference terminal.

According to one embodiment, the sets of light-emitting diodes are classified by ascending ranks from a first set of light-emitting diodes at the first end of the light-emitting circuit to a last set of light-emitting diodes at the second end of the light-emitting circuit; for each connection circuit of the optoelectronic circuit, excluding the last set of light-emitting diodes (that is to say the set of light-emitting diodes having the highest rank), the second terminal of the conduction component is linked to an electrical connection connecting two resistive components connected in series together.

According to one embodiment, for each conduction component, the control circuit is adapted to regulate the first voltage to track the second voltage reduced by the third voltage which decreases with the rank of the set of light-emitting diodes to which the conduction component is linked.

According to one embodiment, the differential amplifier receives as input a differential voltage corresponding to the difference between the first voltage and the second voltage.

According to one embodiment, the differential amplifier is adapted to provide a first current and a second current, the control circuit comprising a first multi-output current mirror adapted to replicate, for each conduction component, the first current or a third current multiplied by a first copy factor, and a second multi-output current mirror adapted to replicate, for each conduction component, the second current or the third current multiplied by a second copy factor, the ratio between the first copy factor and the second copy factor being different for each conduction component.

According to one embodiment, the optoelectronic circuit comprises, for each conduction component, a capacitor linked to the conduction component or integrated into the conduction component, the first current mirror comprising a capacitor charging circuit and the second current mirror comprising a capacitor discharging circuit.

According to one embodiment, the differential amplifier comprises a differential pair comprising a first transistor receiving the first voltage and a second transistor receiving the second voltage.

According to one embodiment, the first transistor may be a MOS transistor whose gate receives the first voltage and the second transistor may be a MOS transistor whose gate receives the second voltage.

According to one embodiment, each conduction component comprises a MOS transistor.

According to one embodiment, the first current mirror comprises, for each conduction component, a first replication block linked to the gate of the MOS transistor of the conduction component and adapted to provide the first current multiplied by the first copy factor, and the second current mirror comprises, for each conduction component, a second replication block linked to the gate of the MOS transistor of the conduction component and adapted to provide the second current multiplied by the second copy factor.

According to one embodiment, the optoelectronic circuit comprises a capacitor mounted between the first power supply terminal and the second reference terminal and allowing the variable voltage to remain at a value greater than a threshold voltage of the first set of light-emitting diodes mounted between the first power supply terminal and the first conduction component. The capacitor mounted at the input allows avoiding the risk of periods of absence of light emission and therefore avoids any uncomfortable stroboscopic effect.

According to one embodiment, the third voltage varies depending on the temperature.

### BRIEF DESCRIPTION OF THE DRAWINGS

Other aspects, advantages, and features of the disclosure will become more apparent upon reading the following detailed description of the embodiments referred to therein, given by way of non-limiting example, and with reference to the appended drawings, in which:

FIG. 1 represents an electrical diagram of an embodiment of an optoelectronic circuit according to the disclosure.

FIG. 2 represents an electrical diagram of an embodiment of the control circuit used in the optoelectronic circuit of FIG. 1.

FIG. 3 represents a particular case of the embodiment of FIG. 1 where N is equal to 3.

FIG. 4 shows voltage, current, and power timing diagrams during operation of the embodiment of the optoelectronic circuit in accordance with the disclosure of FIG. 1.

### DETAILED DESCRIPTION OF THE DRAWINGS

In the figures and in the remainder of the description, the same references represent identical or similar elements. Furthermore, the different elements are not represented to scale to enhance clarity in the figures. Moreover, the different embodiments and variants are not mutually exclusive and may be combined with one another.

Unless otherwise specified, the expression «substantially» means to within 10%, preferably to within 5%. Moreover, in this description, the term «connected» is used to designate a direct electrical connection, without an intermediate electronic component, for example by means of a conductive track, and the term «linked» is used to designate either a direct electrical connection (then meaning «connected») or a connection via one or more intermediate components (resistor, capacitor, etc.).

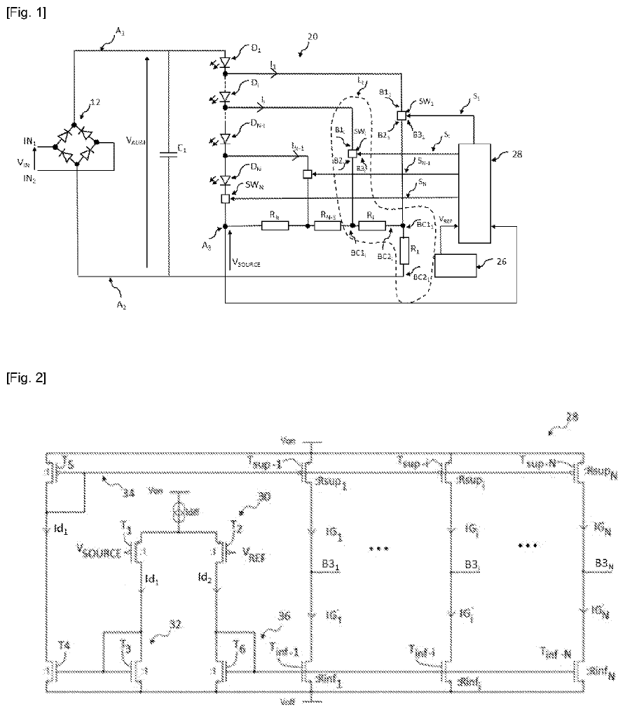

FIG. 1 shows an electrical diagram of an embodiment of an optoelectronic circuit 20 comprising a first power supply terminal A₁ and a second reference terminal A₂, the first power supply terminal A₁ and the second reference terminal A2 being intended to be connected to a voltage source providing the optoelectronic circuit 20 with a variable voltage V_{ALIM} containing an alternation of increasing positive phases and decreasing positive phases.

According to one embodiment, the optoelectronic circuit 20 may comprise a rectifier circuit 12 receiving a supply voltage V_{IN} between two terminals IN₁ and IN₂ and providing the rectified variable voltage V_{ALIM} between the first supply terminal A₁ and the second reference terminal A₂. Alternatively, the optoelectronic circuit 20 may receive a rectified voltage directly, in which case the rectifier circuit 12 may not be present.

The potential at the second reference terminal A2 may correspond to a low reference potential Voff, for example 0V, to which the voltages of the optoelectronic circuit 20 are referenced. Unless otherwise indicated, the potentials are referenced in the remainder of the description relative to the low reference potential Voff. A high reference potential, called Von, may be provided from the variable voltage V_{ALIM} at the first supply terminal A₁.

The optoelectronic circuit 20 comprises sets of light-emitting diodes Dᵢ linked together in a series circuit, which series circuit being linked to the first power supply terminal A₁. The number i of the sets of light-emitting diodes D_{i i}s an integer ranging from 0 to N, where N is an integer comprised between 2 and 200. Each of the sets of light-emitting diodes D₁ to D_{N} comprises at least one elementary light-emitting diode. Preferably, each set of light-emitting diodes Di is composed of at least two elementary light-emitting diodes connected in series and/or in parallel. The sets of light-emitting diodes Dᵢ, i varying from 1 to N, may comprise the same number of elementary light-emitting diodes or different numbers of elementary light-emitting diodes.

The optoelectronic circuit 20 comprises a plurality of conduction components SWi where each conduction component SWᵢ is associated with a single one of the sets of light-emitting diodes Dᵢ. Each conduction component SWᵢ has an electrical conductance that varies as a function of a control signal Sᵢ and includes a first terminal B1ᵢ, a second terminal B2ᵢ, and a third terminal B3ᵢ. Each conduction component SWᵢ is adapted to ensure the driving of a set of light-emitting diodes Dᵢ associated with it. In the present exemplary embodiment, each conduction component SWᵢ is associated with a single one of the sets of light-emitting diodes Dᵢ, and each set of light-emitting diodes Dᵢ is associated with a single one of the conduction components SWᵢ. Therefore, the number of sets of light-emitting diodes Di is identical to the number of conduction components SWᵢ. In FIG. 1, for i varying from 1 to N, the current flowing in the conduction component SWi is called Iᵢ.

The optoelectronic circuit 20 also comprises a plurality of connection circuits Lᵢ, the second reference terminal A₂ being linked to each set of light-emitting diodes Dᵢ by one of said connection circuits Lᵢ, each connection circuit Lᵢ, on the one hand, comprising one of said conduction components SWᵢ and at least one resistive component Rᵢ connected in series with said conduction component SWᵢ of said connection circuit Lᵢ, on the other hand, being configured such that the first terminal B1ᵢ of the conduction component SWᵢ is linked to the set of light-emitting diodes Di associated therewith and that a first connection terminal Bc1ᵢ of the resistive component Rᵢ is connected to the second terminal B2ᵢ of the conduction component SWᵢ of said connection circuit Lᵢ and that a second connection terminal Bc2ᵢ of the resistive component Rᵢ is linked to the second reference terminal A₂. The optoelectronic circuit 20 comprises a control circuit 28 comprising a differential amplifier 30 and as many output stages as there are conduction components SWᵢ that the optoelectronic circuit 20 comprises, each of said output stages being connected to the third terminal B3ᵢ of one of said conduction components SWᵢ, the control circuit 28 being adapted to provide, for each connection circuit Lᵢ, the control signal Sᵢ from the comparison between, on the one hand, a first voltage V_{SOURCE} taken between a first potential, between the first connection terminal Bc1ᵢ of the resistive component Rᵢ and the second terminal B2ᵢ of the conduction component SWᵢ of this connection circuit Lᵢ, and the second reference terminal A₂, and on the other hand at least one second voltage V_{REF} identical for all the conduction components SWᵢ, the control circuit 28 being adapted to control the first voltage V_{SOURCE} to the second voltage V_{REF} offset by a third voltage V_{OFFSETi}, different for each output stage of the control circuit 28.

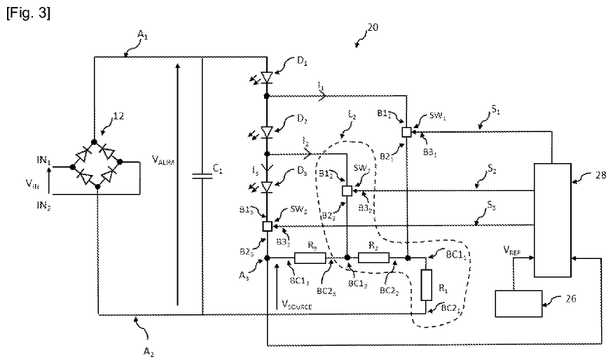

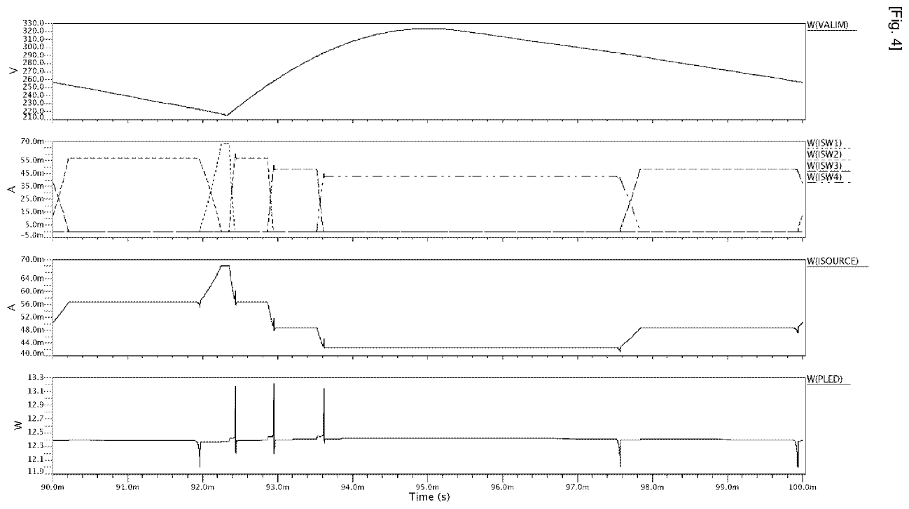

In order to explain the operation of the optoelectronic circuit 20, it is considered that an optoelectronic circuit having a simplified structure. FIG. 3 represents a special case of the embodiment of FIG. 1 where N is equal to 3. The control circuit 28 comprises three output stages connected to the three conduction components SW₁, SW₂, and SW₃ at the third terminals B3₁, B3₂, and B3₃, respectively. A capacitor C₁ connected to the input of the optoelectronic circuit 20 between the first supply terminal A₁ and the second reference terminal A2 allows the variable voltage V_{ALIM} to be maintained at a value greater than the threshold voltage of the first set of light-emitting diodes Dᵢ. This arrangement ensures that the first set of light-emitting diodes Dᵢ remains conductive and that the optoelectronic circuit emits light continuously, regardless of the variation in the variable voltage V_{ALIM}. In the following, we focus on the operation of the simplified optoelectronic circuit 20 shown in FIG. 3.

When the value of the variable voltage V_{ALIM} is lower than the sum of the threshold voltages of the sets of diodes D₁ and D₂, only the set of diodes D₁ is conductive.

The control circuit 28 supplies the connection circuit L₁ (comprising R₁ and SW₁) with the control signal S₁ based on the comparison between the first voltage V_{SOURCE} (taken between a potential between the first connection terminal Bc1₁ and the second terminal B2₁ and the second reference terminal A₂) and the second voltage V_{REF}. The control circuit 28 makes it possible to control the first voltage V_{SOURCE} to the second voltage V_{REF} offset by the third voltage V_{OFFSET1}. In this case, all three conduction components are conductive.

When the value of the variable voltage V_{ALIM} becomes greater than the sum of the threshold voltages of the sets of diodes D₁ and D₂ but remains less than the sum of the threshold voltages of the sets of diodes D₁, D₂, and D₃, only the sets of diodes D₁ and D₂ are conductive. The control circuit 28 supplies the connection circuit L₂ (comprising R₁, R₂, and SW₂) with the control signal S₂ based on the comparison between the first voltage V_{SOURCE} (taken between a first potential between the first connection terminal Bc1₂ and the second terminal B2₂ and the second reference terminal A₂) and the second voltage VREF. The control circuit 28 makes it possible to control the first voltage V_{SOURCE} to the second voltage VREF offset by the third voltage V_{OFFSET2}. In this case, the conduction components SW₂ and SW₃ are conductive and SW₁ is turned off.

When the value of the variable voltage V_{ALIM} is greater than the sum of the threshold voltages of the sets of diodes D₁, D₂, and D₃, all the sets of diodes D₁, D₂, and D₃ are conductive. The control circuit 28 supplies the connection circuit L₃ (comprising R₁, R₂, R₃, and SW₃) with the control signal S₃ based on the comparison between the first voltage V_{SOURCE} (taken between a first potential between the first connection terminal Bc1₃ and the second terminal B2₃ and the second reference terminal A₂) and the second voltage V_{REF}. The control circuit 28 makes it possible to regulate the first voltage V_{SOURCE} to track the second voltage V_{REF}, offset by the third voltage V_{OFFSET3}. In this case, the conduction components SW₁ and SW₂ are turned off, and SW₃ is conductive.

Let us now consider again the optoelectronic circuit 20 of FIG. 1. Each conduction component SWᵢ is a circuit whose equivalent electrical resistance varies between a maximum value and a minimum value depending on the control signal Sᵢ that it receives from the control circuit 28. When the equivalent electrical resistance of the conduction component SWᵢ is at its maximum value, the conduction component SWᵢ is substantially equivalent to an open switch. According to this embodiment, for i varying from 1 to N, when a conduction component SWᵢ is conductive, the conduction components SWᵢ to SWᵢ₋₁ are turned off and the conduction components SWᵢ₊₁ to SWN are conductive.

According to one embodiment, the control signal Sᵢ of each conduction component SWᵢ is a signal that can vary continuously between a first value and a second value. According to the embodiments, the equivalent electrical resistance of the conduction component SWᵢ may decrease or increase when the control signal varies from the first value to the second value. The first and second values of the control signals Sᵢ, i varying from 1 to N, may not be the same for all the conduction components SWᵢ.

According to one embodiment, the sets of light-emitting diodes Dᵢ are connected together so as to constitute a light-emitting circuit in which the sets of light-emitting diodes Dᵢ are in series with each other, the light-emitting circuit having a first end electrically connected to the first power supply terminal A₁ and a second end linked to a node A₃; the optoelectronic circuit 20 comprises as many resistive components Rᵢ as there are sets of light-emitting diodes Dᵢ, and said resistive components Rᵢ are connected in series with each other, between the node A₃ and the second reference terminal A₂.

According to one embodiment, the light-emitting diodes Dᵢ are classified in increasing ranks from a first set of light-emitting diodes Dᵢ at the first end of the light-emitting circuit to a last set of light-emitting diodes Dᵢ at the second end of the light-emitting circuit; for each connection circuit Lᵢ of the optoelectronic circuit 20, excluding the last set of light-emitting diodes D_{N}, the second terminal B2; of the conduction component SWᵢ is linked to an electrical connection connecting two resistive components Rᵢ connected in series with each other.

According to the present embodiment, the plurality of connection circuits Lᵢ may be presented as follows:
the circuit L₁, linking A₂ to D₁, comprises R₁ and SW₁,
the circuit L₂, linking A₂ to D₂, comprises R₁ and R₂ connected together in a series connection and SW₂,
the circuit L₃, linking A₂ to D₃, comprises R₁, R₂, and R₃ connected together in a series connection and SW₃,
. . .
the circuit L_{N}, connecting A₂ to D_{N}, comprises R₁, R₂, . . . , R_{N} connected together in a series connection and SW_{N}.

Said resistive components Rᵢ are intended to be traversed by a current I_{SOURCE}, corresponding to the current supplying the conductive sets of light-emitting diodes Dᵢ. During an ascending phase of the variable voltage V_{ALIM}, the number of conductive sets of light-emitting diodes Dᵢ gradually increases as the value of the variable voltage V_{ALIM} exceeds the threshold voltage of the considered set of light-emitting diodes Dᵢ. Similarly, during a descending phase of the variable voltage V_{ALIM}, the number of conductive sets of light-emitting diodes Dᵢ gradually decreases as the value of the variable voltage V_{ALIM} falls bellow the threshold voltage of the considered set of light-emitting diodes Dᵢ. Thus, the number of resistive components Ri and conductive sets of light-emitting diodes Dᵢ varies proportionally with the variable voltage V_{ALIM}. The increase in the number of resistive components Rᵢ allows then advantageously limiting the value of the current I_{SOURCE} when there is an increase in the value of the variable voltage V_{ALIM}. Consequently, the present arrangement of resistive components Rᵢ makes it possible to maintain the power of the sets of light-emitting diode Dᵢ at a substantially constant value regardless of the variation in the variable voltage V_{ALIM}.

FIG. 4 shows timing diagrams, obtained by simulation, of the variable voltage V_{ALIM}, the current I_{SOURCE}, the currents I₁, I₂, I₃ and I₄ flowing in the conduction components SWᵢ in a particular case where N is equal to 4 and the power P_{LED} of the sets of light-emitting diodes Dᵢ. It can be seen that during a descending phase of the variable voltage V_{ALIM}, the value of the current ISOURCE, flowing in the conductive sets of light-emitting diodes Dᵢ and in the resistive components Ri forming part of the considered connection circuit Lᵢ, increases progressively. This increase is linked to the decrease in the number of resistive components Ri which varies proportionally with the variable voltage VA_{LIM}. Similarly, during an ascending phase of the variable voltage V_{ALIM}, the value of the current I_{SOURCE}, flowing in the conductive sets of light-emitting diodes Dᵢ and in the resistive components Rᵢ, gradually decreases. This decrease is linked to the increase in the number of resistive components Rᵢ, which varies proportionally with the variable voltage V_{ALIM}. This allows having a power in the sets of light-emitting diodes Dᵢ that is substantially constant regardless of the variable voltage V_{ALIM}, as can be seen in the power timing diagram P_{LED}.

According to one embodiment, for each conduction component SWᵢ, the control circuit 28 is adapted to regualte the first voltage V_{SOURCE} to track the second voltage V_{REF} reduced by the third voltage V_{OFFSETi}, which decreases with the rank of the set of light-emitting diodes Di to which the conduction component SW; is linked.

The second voltage V_{REF} can be supplied to the optoelectronic circuit 20 by a circuit 26, according to the embodiment, either internal or external to the optoelectronic circuit 20. The second voltage V_{REF} may also be obtained from a modulation signal supplied to the optoelectronic circuit 20 by an external circuit. The second voltage V_{REF} or the modulation signal may be provided by a controller, in particular a controller that can be operated by a user or a light sensor.

According to one embodiment, the differential amplifier 30 receives as its input a differential voltage corresponding to the difference between the first voltage V_{SOURCE} and the second voltage V_{REF}.

FIG. 2 represents an electrical diagram of an embodiment of the control circuit 28 used in the optoelectronic circuit 20. The differential amplifier 30 is adapted to provide a first current Id₁ and a second current Id₂, the control circuit 28 comprising a first current mirror 32, 34 with multiple outputs adapted to replicate, for each conduction component SWi, the first current Id1 or a third current multiplied by a first copy factor, and a second current mirror 36 with multiple outputs adapted to replicate, for each conduction component SWi, the second current Id₂ or the third current multiplied by a second copy factor, the ratio between the first copy factor and the second copy factor being different for each conduction component SWᵢ.

According to one embodiment, for each conduction component SWᵢ, a capacitor is connected to the conduction component SWᵢ or integrated into the conduction component SWᵢ, the first current mirror 34 comprising a capacitor charging circuit Tₛᵤₚ₋ᵢ and the second current mirror 36 comprising a capacitor discharging circuit T_{inf-i}.

According to one embodiment, the differential amplifier 30 comprises a differential pair comprising a first transistor T₁ receiving the first voltage VSOURCE and a second transistor T₂ receiving the second voltage V_{REF}.

The first transistor T₁ may be a MOS transistor whose gate receives the first voltage V_{SOURCE} and the source is linked to the terminal of a current source I_{diff}, as can be seen in FIG. 2, and the other terminal of the current source Idiff may be linked to the source of the high reference potential Von. The second transistor T₂ may be a MOS transistor whose gate receives the second voltage V_{REF} and the source is connected to the current source I_{diff}. The current at the drain of the transistor T₁ corresponds to the first current Id₁, and the current at the drain of the transistor T₂ corresponds to the second current Id₂. According to one embodiment, the transistors T₁ and T₂ have the same characteristics, in particular the same form factor W/L. The form factor of a transistor channel is the ratio between the width and the length of the channel.

The first current mirror 32 may comprise two transistors T₃ and T₄, for example N-channel MOS transistors. The drain of the transistor T₃ is linked to the drain of the transistor T₁ and the source of the transistor T₃ is linked to the source of the low reference potential Voff, and its gate is linked to the drain. The source of the transistor T₄ is linked to the source of the low reference potential Voff, and its gate is linked to the gate of transistor T₃. According to one embodiment, the two transistors T₃ and T₄ have the same characteristics, in particular the same form factor, and the current flowing in the transistor T₄ is therefore equal to the current Id₁ flowing in T₃.

The first current mirror 34 may comprise a transistor T₅, for example a P-channel MOS transistor, whose drain is linked to the drain of the transistor T₄, whose source is linked to the source of the high reference potential Von, and whose gate is linked to the drain. The first current mirror 34 may further comprise, for each conduction component SWᵢ, i varying from 4 to N, one of said circuit Tₛᵤₚ₋ᵢ. The circuit Tₛᵤₚ₋ᵢ may, for example, be a P-channel MOS transistor, whose source is linked to the source of the high reference potential Von, whose gate is linked to the gate of transistor T₅, and whose drain is connected to the third terminal B3ᵢ of the conduction component SWi. According to one embodiment, the transistors Tsup-i may not have the same characteristics with respect to each other and with respect to the transistor T₅. Rₛᵤₚ₋ᵢ denotes the ratio between the channel form factor of transistor Tₛᵤₚ₋ᵢ and the channel form factor of transistor T₅. In particular, Rₛᵤₚ₋ᵢ may be different from Rₛᵤₚ₋ⱼ, with i different from j. IGᵢ denotes the current at the drain of transistor Tₛᵤₚ₋ᵢ.

The second current mirror 36 may comprise a transistor T₆, for example a N-channel MOS transistor, whose drain is linked to the drain of the transistor T₂, whose source is linked to the source of the low reference potential Voff, and whose gate is linked to the drain. The second current mirror 36 may comprise, for each conduction component SWᵢ, i varying from 1 to N, one of said circuit T_{inf-i}. The circuit T_{inf-i} may, for example, be an N-channel MOS transistor, whose source is linked to the source of the low reference potential Voff, whose gate is linked to the gate of transistor T₆, and whose drain is linked to the third terminal B3ᵢ of the conduction component SWi. According to one embodiment, the transistors T_{inf-i} may not have the same characteristics relative to each other and relative to the transistor T₆. R_{inf-i} denotes the ratio between the channel form factor of the transistor T_{inf-i} and the channel form factor of the transistor T₆. In particular, R_{inf-i} may be different from R_{inf-j}, with i different from j. IG′ᵢ denotes the drain current of the transistor Tₛᵤₚ₋ᵢ.

According to one embodiment, each conduction component SW; comprises a MOS transistor. The control signal Sᵢ is the potential at the gate of the MOS transistor of the conduction component SWᵢ at its third terminal B3ᵢ. The drain of the MOS transistor corresponds to the first terminal B1ᵢ, and the source of the MOS transistor corresponds to the second terminal B2i. According to another embodiment, the conduction component SWᵢ may comprise two MOS transistors, which advantageously allows increasing the switching speed of the conduction component SWᵢ. Alternatively, the conduction component SWi may correspond to a transistor other than a MOS transistor, a relay, a microelectromechanical system, and generally to any element whose electrical conductivity can be controlled by voltage or current. According to one embodiment, the first current mirror 34 comprises, for each conduction component SWᵢ, a first replication block Tₛᵤₚ₋ᵢ connected to the gate of the MOS transistor of the conduction component SWᵢ and adapted to provide the first current Id₁ multiplied by the first copy factor, and the second current mirror 36 comprises, for each conduction component SWᵢ, a second replication block T_{inf-i} connected to the gate of the MOS transistor of the conduction component SWᵢ and adapted to provide the second current Id₂ multiplied by the second copy factor.

According to one embodiment, and in an ascending phase of the variable voltage V_{ALIM}, while the sets of light-emitting diodes D₁ to Dᵢ₋₁ are conductive, the sets of light-emitting diodes Dᵢ to D_{N} are turned off, the control signals S₁ to Sᵢ₋₂ are at Voff, the signals Sᵢ to S_{N} are at Von, and the signal Sᵢ₋₁ is at a voltage value allowing the single conduction component SWᵢ₊₁ to impose the current I_{SOURCE} in the sets of light-emitting diodes, when the voltage across the terminals of the sets of light-emitting diodes Dᵢ exceeds the threshold voltage of the set of light-emitting diodes Dᵢ, the latter becomes conductive and a current begins to flow in the set of light-emitting diodes Dᵢ, the conduction component SWᵢ, and the resistive components Rᵢ. This results in a temporary decrease in the total equivalent impedance between the first supply terminal A₁ and the node A₃, and therefore a temporary increase in voltage VSOURCE. This increase in voltage VSOURCE results in a decrease in current Id₁ flowing through the transistor T₁ of differential pair 30. As a result, the current reproduced by each transistor Tₛᵤₚ₋ᵢ decreases for I varying from 1 to N. Since there is an equivalent capacitance at each third terminal B3ᵢ, i varying from 1 to N, which may correspond to a distint capacitor or to a parasitic capacitance of another electronic component, the voltage at the third terminal B3ᵢ decreases until it reaches approximately the potential Voff, while the voltage at the third terminal B3ᵢ also decreases to its equilibrium point, allowing the conduction component SWᵢ to alone impose the voltage V_{SOURCE} at the level of V_{REF}-V_{OFFSETi}. The conduction component SWᵢ₋₁ therefore turns off, and simultaneously the conduction component SWᵢ becomes increasingly conductive. All the current then flows through the conduction component SWᵢ. The control circuit 28 then regulates the voltage V_{SOURCE} to track the voltage V_{VREF} reduced by V_{OFFSETi} by the conduction component SWᵢ, the offset voltage V_{OFFSETi} between the voltage V_{SOURCE} and the voltage V_{REF} being lower than the offset voltage V_{OFFSETi-1}. In the case where each conduction component SWi comprises a MOS transistor whose gate receives the signal Sᵢ, this means that the voltage at the gate of transistor SWᵢ₊₁ decreases and the transistor SWᵢ₋₁ becomes gradually less conductive until it reaches its non-conductive state. At equilibrium, the potential at the third terminal B3ᵢ is equal to the sum of the voltage V_{SOURCE} and the gate-source voltage of the transistor SWᵢ.

According to one embodiment, and in a descending phase of the variable voltage V_{ALIM}, while the sets of light-emitting diodes D₁ to Dᵢ are conductive, the light-emitting diodes Dᵢ₊₁ to D_{N} are turned off, the signals S₁ to Sᵢ₋₁ are at Voff, the signals Sᵢ₊₁ to S_{N} are at Von, and the signal Sᵢ is at a voltage value allowing the single conduction component SWᵢ to impose the current ISOURCE in the sets of light-emitting diodes, when the voltage across the set of light-emitting diodes Dᵢ decreases and falls below the threshold voltage of the set of light-emitting diodes Dᵢ, the latter begins to be turned off. This results in a temporary increase in the equivalent total impedance between the first power supply terminal A₁ and the node A₃, and therefore a temporary decrease in the voltage VSOURCE. This decrease in voltage V_{SOURCE} causes an increase in the current Id₁ flowing through the transistor T₁ of the differential pair 30. As a result, the current reproduced by each transistor Tₛᵤₚ₋ᵢ increases. Since there is an equivalent capacitance at each third terminal B3ᵢ, the voltage at the third terminal B3ᵢ increases until it roughly reaches the potential Von, while the voltage at the third terminal B3ᵢ₋₁ also increases until it reaches its equilibrium point, allowing the conduction component SWᵢ₋₁ to impose only the voltage V_{SOURCE} on V_{REF}-V_{OFFSETi-1}. The conduction component SWᵢ therefore completely turns off, and the conduction component SWᵢ₋₁ becomes increasingly conductive. All the current then flows through the conduction component SWᵢ₋₁. The control circuit 28 then regulates the voltage V_{SOURCE} to track the voltage V_{REF}, reduced by V_{OFFSETi-1} by the conduction component SWᵢ₋₁, the offset voltage V_{OFFSETi-1} exceeds the offset voltage V_{OFFSETi}. In the case where each conduction component SWi comprises a MOS transistor whose gate receives the signal Sᵢ, this means that the voltage at the gate of transistor SWᵢ₋₁ increases and that transistor SW; becomes increasingly conductive, and the transistor SWi₋₁ reaches its fully conductive state.

Furthermore, in the embodiments described above, each transistor Tₛᵤₚ₋ᵢ is adapted to replicate the current Id₁ multiplied by the copy factor Rₛᵤₚ₋ᵢ and each transistor T_{inf-i} is adapted to replicate the current id₂ multiplied by the copy factor R_{inf-i}. Alternatively, each of the transistors T_{inf-i} and Tₛᵤₚ₋ᵢ can be adapted to replicate a reference current, for example, a constant current.

According to one embodiment, the optoelectronic circuit 20 comprises a capacitor C₁ connected between the first supply terminal A₁ and the second reference terminal A₂ and allowing the variable voltage V_{ALIM} to remain at a value greater than a threshold voltage of the set of light-emitting diodes D₁ connected to the first supply terminal A₁. The capacitor C₁ at the input of the optoelectronic circuit 20 allows advantageously avoiding the risk of periods of absence of light emission and therefore avoids any uncomfortable stroboscopic effect.

According to one embodiment, the third voltage V_{OFFSETi} varies as a function of temperature. The offset voltage V_{OFFSETi} can either increase as the temperature increases or decrease as the temperature increases. In the case where the offset voltage VOFFSETi decreases as the temperature increases, an increase in temperature results in a decrease in the current flowing through the resistive components Ri and therefore a reduction in the thermal power supplied by the optoelectronic circuit 20. This provides protection of the optoelectronic circuit 20 against thermal runaway.

1. An optoelectronic circuit comprising a first power supply terminal and a second reference terminal, the first power supply terminal and the second reference terminal being intended to be connected to a voltage source delivering to the optoelectronic circuit a variable voltage containing an alternation of increasing positive phases and decreasing positive phases, the optoelectronic circuit comprising:
sets of light-emitting diodes linked together in a series connection, which series connection is linked to the first power supply terminal;
a plurality of conduction components where each conduction component is associated with a single one of the sets of light-emitting diodes, each conduction component having a variable electrical conductance as a function of a control signal, each conduction component comprising a first terminal, a second terminal and a third terminal;
a plurality of connection circuits, the second reference terminal being connected to each set of light-emitting diodes by one of said connection circuits, each connection circuit on the one hand comprising one of said conduction components (and at least one resistive component connected series with said conduction component of said conduction circuit, on the other hand being configured so that the first terminal of the conduction component is connected to the set of light-emitting diodes associated with it and that a first connection terminal of the resistive component is connected to the second terminal of the conduction component of said connection circuit and that a second connection terminal (of the resistive component is connected to the second reference terminal; and
a control circuit comprising a differential amplifier and as many output stages as there are conduction components (comprised in the optoelectronic circuit, each of said output stages being linked to the third terminal (of one of said conduction components the control circuit being adapted to provide, for each connection circuit, the control signal from the comparison between, on the one hand, a first voltage taken between a first potential, between the first connection terminal of the resistive component and the second terminal of the conduction component of this connection circuit, and the second reference terminal, and on the other hand at least one second voltage identical for all the conductive components, the control circuit being adapted to regulate the first voltage to track the second voltage offset by a third voltage, different for each output stage of the control circuit.

2. The optoelectronic circuit according to claim 1, wherein:
the sets of light-emitting diodes are connected together so as to constitute a light-emitting circuit in which the sets of light-emitting diodes are in series with each other, the light-emitting circuit having a first end electrically connected to the first power supply terminal and a second end connected to a node; and
the optoelectronic circuit comprises as many resistive components as sets of light-emitting diodes;
said resistive components being connected in series with each other, between the node and the second reference terminal.

3. The optoelectronic circuit according to claim 2, wherein:
the sets of light-emitting diodes are classified in ascending ranks from a first set of light-emitting diodes at the first end of the light-emitting circuit to a last set of light-emitting diodes at the second end of the light-emitting circuit;
for each connection circuit of the optoelectronic circuit excluding the last set of light-emitting diodes, the second terminal of the conductive component is linked to an electrical connection connecting two resistive components connected in series with each other.

4. The optoelectronic circuit according to claim 3, wherein, for each conduction component, the control circuit is adapted to regulate the first voltage to the second voltage reduced by the third voltage which decreases with the rank of the set of light-emitting diodes to which the conduction component is linked.

5. The optoelectronic circuit according to claim 1, wherein the differential amplifier receives as input a differential voltage corresponding to the difference between the first voltage and the second voltage.

6. The optoelectronic circuit according to claim 1, wherein the differential amplifier is adapted to provide a first current and a second current, the control circuit comprising a first current mirror with several outputs adapted to replicate, for each conduction component the first current or a third current multiplied by a first copy factor, and a second current mirror with several outputs adapted to replicate, for each conduction component the second current or the third current multiplied by a second copy factor, the ratio between the first copy factor and the second copy factor being different for each conduction component.

7. The optoelectronic circuit according to claim 6, comprising, for each conduction component, a capacitor connected to the conduction component or integrated in the conduction component the first current mirror comprising a capacitor charging circuit and the second current mirror comprising a capacitor discharging circuit.

8. The optoelectronic circuit according to claim 1, wherein the differential amplifier comprises a differential pair comprising a first transistor receiving the first voltage and a second transistor receiving the second voltage.

9. The optoelectronic circuit according to claim 8, wherein the first transistor is a MOS transistor whose gate receives the first voltage and in which the second transistor is a MOS transistor whose gate receives the second voltage.

10. The optoelectronic circuit according to claim 1, wherein each conduction component comprises a MOS transistor.

11. The optoelectronic circuit according to claim 10, wherein the first current mirror comprises, for each conduction component a first replicate block connected to the gate of the MOS transistor of the conduction component and adapted to provide the first current multiplied by the first copy factor and in which the second current mirror comprises, for each conduction component a second replicate block connected to the gate of the MOS transistor of the conduction component and adapted to provide the second current multiplied by the second copy factor.

12. The optoelectronic circuit according to claim 1, comprising a capacitor connected between the first supply terminal and the second reference terminal and allowing the variable voltage to remain at a value greater than a threshold voltage of the set of light-emitting diodes connected to the first supply terminal.

13. The optoelectronic circuit according to claim 1, wherein the third voltage varies as a function of temperature.
